(19) United States
(12) Patent Application Publication
(10) Pub. No.: US 2007/0050705 A1
(43) Pub. Date: Mar. 1, 2007

(54) METHOD OF XML ELEMENT LEVEL COMPARISON AND ASSERTION UTILIZING AN APPLICATION-SPECIFIC PARSER

(76) Inventors: Erxiang Liu, Austin, TX (US); Ningning Wang, Round Rock, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/277,966

(22) Filed: Mar. 30, 2006

Related U.S. Application Data
(63) Continuation-in-part of application No. 11/214,566, filed on Aug. 30, 2005.

(51) Int. Cl. G06F 17/00; G06F 15/00

(52) U.S. Cl. 715/513

(57) ABSTRACT

A method of XML element level comparison is provided. In an exemplary embodiment, the method of XML element level comparison includes creating an application-specific parser for a first incoming XML instance. The method may also include generating a comparison agent. The comparison agent may include the application-specific parser for the first incoming XML instance and an element value of the first incoming XML instance. For example, the application-specific parser includes an XPATH and a comparison code action pair. The method may also include evaluating a second incoming XML instance with the comparison agent at runtime.

### CROSS-REFERENCE TO RELATED APPLICATIONS

The present application is a continuation-in-part under 35 U.S.C. § 120 of U.S. application Ser. No. 11/214,566, entitled “XML COMPILER THAT WILL GENERATE AN APPLICATION SPECIFIC XML PARSER,” filed on Aug. 30, 2005. The present application is related to the following co-pending United States patent applications: United States patent application entitled “METHOD OF XML TRANSFORMATION AND PRESENTATION UTILIZING AN APPLICATION-SPECIFIC PARSER,” Docket No. AUS920050753US1; United States patent application entitled “ENABLEMENT OF MULTIPLE SCHEMA MANAGEMENT AND VERSIONING FOR APPLICATION SPECIFIC XML PARSERS,” Docket No. AUS920050754US1; and United States patent application entitled “GENERATION OF APPLICATION SPECIFIC XML PARSERS USING JAR FILES WITH PACKAGE PATHS THAT MATCH THE XML XPATHS,” Docket No. AUS920050756US1. All of the aforementioned applications are hereby incorporated by reference in their entireties.

### FIELD OF INVENTION

The present invention generally relates to the field of software, and more particularly to a method of application-specific processing of XML files.

### BACKGROUND OF THE INVENTION

Extensible Markup Language (XML) is a widely accepted standard for describing data. XML is a standard that allows an author/programmer and the like to describe and define data (e.g., type and structure) as part of the XML content/document. XML uses syntax tags to identify various types of data in a file. Since XML content may describe data, any application that understands XML regardless of the applications programming language and platform has the ability to process the XML based content.

An XML parser is a software program that reads XML files and makes the information from those files available to applications and programming languages, usually through a known interface. The XML content may optionally reference another document or set of rules that define the structure of an XML document/content. This other document or set of rules is often referred to as a schema. When an XML document references a schema, some parsers may check for validity in which the parser determines if the document follows the rules schema.

The Extensible Markup Language (XML) has become the industry standard for exchanging data across systems because of the language's flexibility and consistent syntax. However, conventional XML parsing (e.g., parsing by use of a general-purpose external parser) is slow in many applications. General-purpose parsers process XML content into general-purpose data structures, then apply run-time analysis to rebind the data to application-specific structures. Extra space is consumed by intermediate data structures (e.g., general purpose data structures) and extra time may be spent creating and analyzing them. Moreover, it is labor intensive to write the conversion code that converts the general-purpose data structures to application-specific data structures required for final processing.

In e-business applications and systems, very often XML instances or fragments that conform to the same schema are compared and assertion is performed at the element level for authorization, validation and flow control purposes. For example, in a business-to-business system, user's input of credit card information is compared with the credit card service provider record and a “valid” or “invalid” result is returned based on comparison of elements “card_number,” “expiration_date,” and “name_on_card.” A further example may be observed in a message driven system in which components of the system retrieve messages from an enterprise service bus and action determination is based on evaluation of certain token(s) of the message.

Current algorithms for comparison typically include parsing of both XML instances by general purpose XML parsers and comparing the parsing results of element values from both instances. Such process may be very resource consuming and slow because the process requires parsing of both instances. Further, general purpose parsers are often associated with various shortcomings.

There are three broad types of conventional XML parsers: SAX (Simple API for XML) parsers, DOM (Document Object Model) parsers, and data-binding parsers. Typical commercially available parsers use DOM parsers and SAX parsers together. Each type of XML parser defines a standard for accessing and manipulating XML documents.

A SAX parser uses an event-driven model to process XML content. A SAX parser initiates a series of events as it reads an XML document from beginning to end. The events are passed to event handlers, which provide access to the content in the document. Some of these event handlers check the syntax of the XML document (e.g., syntactic events). In conventional SAX parsers, a developer has to program the event handlers (e.g., developer-written events). In addition, a SAX parser invokes developer-written callback routines to manage the syntactic events. A callback routine is a routine that is executed as part of the operation of some other routine.

A limitation of the SAX parser is the requirement for manual programming of the event handlers and callback routines. Further, the conventional SAX parser perform a number of routines such as scanning the XML input multiple times, creating a number of intermediate data structures and the like while facilitating the parsing of the XML document require a great deal of time to perform.

In contrast to a SAX parser, a DOM parser first parses an XML document to build an internal, tree-shaped representation of the XML document. An application programmer interface (API) is then employed to access the contents of the document tree for further analysis. Such configuration results in slow parsing because the state information that is required for analysis was available at parse time resulting in a redundancy. In addition, DOM parsers typically limit parallel processing by building the tree before invoking analysis code.

In addition, a data-binding parser operates by mapping XML elements to element-specific objects. Such parsers are limited for data-binding engines often use high-cost methods such as reflection and run-time rule evaluation.

Therefore, it would be desirable to provide a method and an apparatus for performing comparison of XML strings which not as labor intensive as those associated with conventional parsers.

### SUMMARY OF THE INVENTION

In a first aspect of the invention, a method of XML element level comparison is provided. The method of XML element level comparison includes creating an application-specific parser for a first incoming XML instance. The method may also include generating a comparison agent. The comparison agent may include the application-specific parser for the first incoming XML instance and an element value of the first incoming XML instance. For example, the application-specific parser includes an XPATH and a comparison code action pair. The method may also include evaluating a second incoming XML instance with the comparison agent at runtime.

In a further aspect of the present invention, a computer program product including a computer useable medium including computer usable program code for a method of XML element level comparison is provided. The computer program product may include computer usable program code for creating an application-specific parser for a first incoming XML instance. The computer program may also include computer usable program code for generating a comparison agent. For example, the comparison agent may include the application-specific parser for the first incoming XML instance and an element value of the first incoming XML instance. The application-specific parser may include an XPATH and a comparison code action pair. In addition, the computer program product may also include computer usable program code for evaluating a second incoming XML instance with the comparison agent at runtime.

In an additional aspect of the present invention, a method of comparing XML instances is provided. The method may include creating a comparison agent. The comparison agent may include an application-specific parser for a first incoming XML instance. In addition, the application-specific parser may include a semantic action definition for asserting an element value of the first incoming XML instance. The method may also include evaluating a second incoming XML instance with the comparison agent at runtime, the second incoming XML instance being parsed by the application-specific parser.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method of generating an application-specific parser for comparison/assertion of XML instances in accordance with an exemplary embodiment of the present invention;

FIG. 2 is flow diagram illustrating a method for comparison/assertion of XML instances in accordance with an exemplary embodiment of the present invention, wherein the application-specific parser generated by the method illustrated in FIG. 1 is employed; and

FIG. 3 is a block diagram illustrating a system for comparison/assertion of XML instances in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

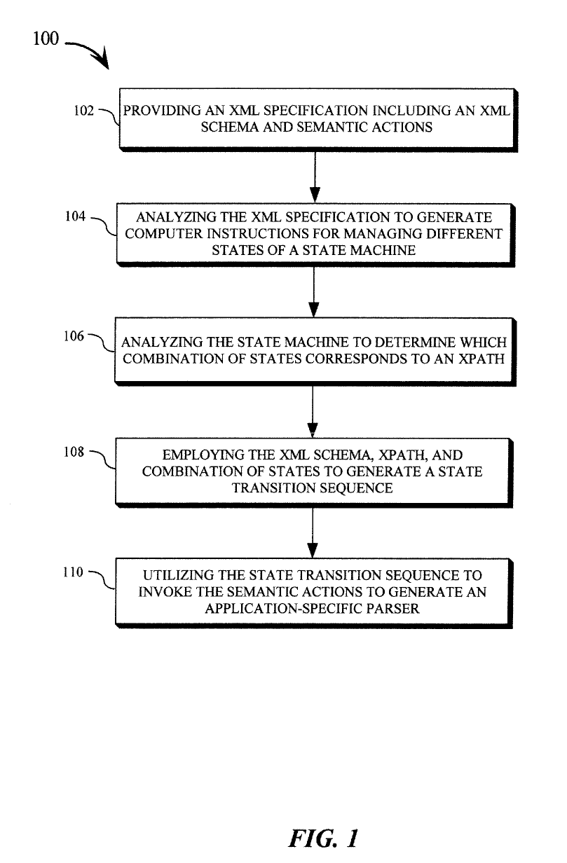

Referring to FIG. 1, a method 100 for generating an application-specific parser for comparison/assertion of XML instances in accordance with an exemplary embodiment of the present invention is shown. In an embodiment, the method 100 includes providing an XML specification including an XML schema and semantic actions. For example, the XML schema may specify syntax, data element, and data type while the semantic actions may include a pairing of XPATH strings and an action code. For comparison/assertion application-specific parsers, the semantic action definition is assertion of the element values and the semantic action is comparison.

The method 100 may also include analyzing the XML specification to generate computer instructions for managing different states of a state machine 104. For example, a state machine may be generated for valid syntactic events (such events are defined based on the operation of the semantic actions on the XML schema). In addition, the method 100 may include analyzing the state machine to determine which combination of states corresponds to an XPATH 106.

XPATH (acronym for XML path language) is a language which is primarily used to address parts of an XML document and find information in such document. For example, XPATH is used to navigate through elements and attributes in an XML document. In addition, XPATH provides basic facilities for manipulation of strings, numbers and Booleans. XPATH is designed to be used with XSLT and X pointer. Further, XPATH treats an XML document as a logical ordered tree of nodes. There are different types of nodes, including element nodes, attribute nodes, and text nodes. XPATH defines a way to compute a string-value for each type of node. An action pair is the action that is taken in conjunction with the XPATH instructions.

In further exemplary embodiments, the method 100 of generating an application-specific parser may include employing the XML schema, XPATH, and the combination of states to generate a state transition sequence 108. The state transition sequence may then be utilized to invoke the semantic actions to generate an application-specific parser 110.

It is contemplated that compiler technology may be used to automatically generate an application-specific parser. It is further contemplated that the method 100 may be implemented in a software generation tool.

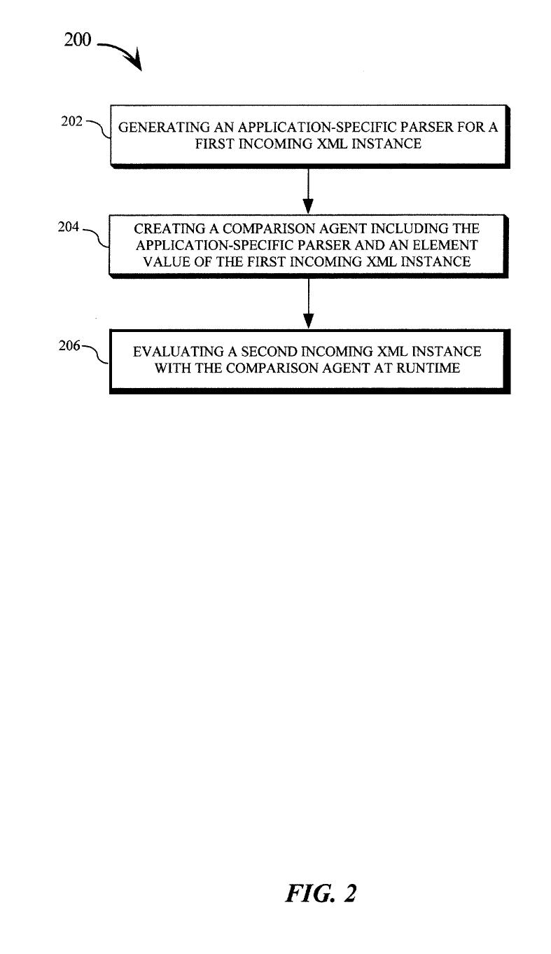

Referring to FIG. 2, a method 200 of XML element level comparison is provided. In an exemplary embodiment, the method 200 of XML element level comparison includes generating an application-specific parser for a first incoming XML instance 202. For example, the method 100 described in detail above may be employed to generate the application-specific parser for the first incoming XML instance. In addition, the method 200 includes creating a comparison agent including the application-specific parser and an element value of the first incoming XML instance 204. In an embodiment, the application-specific parser includes an XPATH and a comparison code action pair. In the present embodiment, the element value of the first incoming XML instance is retrieved by XPATH. It is contemplated that a compiler may be employed to generate the comparison agent.

In a further exemplary embodiment, the method 200 includes evaluating a second incoming XML instance with the comparison agent at runtime 206. For example, evaluating the second incoming XML instance with the comparison agent includes the comparison agent parsing the second XML instance. In an embodiment, the second incoming XML instance includes an element value. In an additional embodiment, the evaluating the second incoming XML instance with the comparison agent includes comparing the element value of the first incoming XML instance with the element value of the second incoming XML instance.

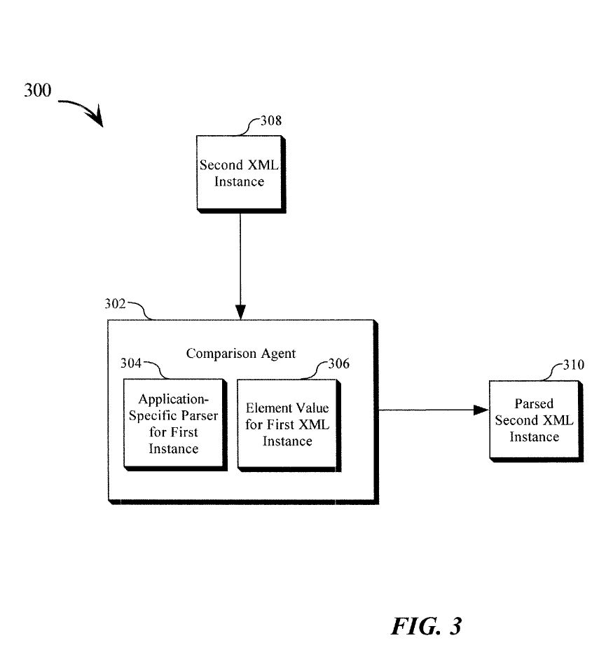

Referring to FIG. 3, a system 300 for comparison/assertion of XML instances in accordance with an exemplary embodiment of the present invention is disclosed. The system 300 includes a comparison agent 302. The comparison agent 302 may be generated by compiler technology. In an exemplary embodiment, the comparison agent 302 includes an application-specific parser 304 for a first XML instance and an element value 306 for the first XML instance. In a configuration, the “to-be-compared” element value of an XML instance is retrieved by XPATH and is built into the comparison agent 302. It is contemplated that comparison agents 302 may be generated for frequently compared instances. For example, such agents 302 could be used in e-business applications and systems. In an embodiment, a second XML instance 308 is parsed by the comparison agent 302 for the first XML instance yielding a parsed second XML instance 310. Such configuration allows instances to be parsed at a speed greater than that observed with current systems for only the second instance needs to be parsed. Runtime analysis time is reduced for only the data necessary to the comparison/assertion is parsed in comparison to prior art systems which parse all information and typically store the whole tree structure. It is contemplated that multiple element values may be compared with the present system.

It is to be understood that the disclosed invention may be employed in a number of systems including embedded systems such as a Service Management Framework (SMF). Further, the present invention may be utilized by consulting services such as WebSphere Commerce (WCS) and WebSphere Business Integration (WBI). In addition, the invention may be used in performance critical applications such as SMF and web services. Moreover, the instant invention may be incorporated as a plug-in into an Integrated Development Environment (IDE) such as WebSphere Studio Application Developer (WSAD), Eclipse, and the like.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become couple to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages is to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of Extensible Markup Language (XML) element level comparison, comprising steps of:
creating an application-specific parser for a first incoming XML instance;
generating a comparison agent, the comparison agent including:
the application-specific parser for the first incoming XML instance, the application-specific parser including XML path language (XPATH) and a comparison code action pair; and
an element value of the first incoming XML instance; and
evaluating a second incoming XML instance with the comparison agent at runtime.

2. The method as claimed in claim 1, wherein the step of creating an application-specific parser is performed by a compiler.

3. The method as claimed in claim 1, wherein the second incoming XML instance includes an element value.

4. The method as claimed in claim 3, wherein the step of evaluating the second incoming XML instance with the comparison agent includes comparing the element value of the first incoming XML instance with the element value of the second incoming XML instance.

5. The method as claimed in claim 1, wherein the step of generating a comparison agent is performed by a compiler.

6. The method as claimed in claim 1, wherein the step of evaluating the second incoming XML instance with the comparison agent includes the comparison agent parsing the second XML instance.

7. The method as claimed in claim 1, wherein the element value of the first incoming XML instance is retrieved by XPATH.

8. A computer program product, comprising:
a computer useable medium including computer usable program code for a method of Extensible Markup Language (XML) element level comparison, the computer program product including:
computer usable program code for creating an application-specific parser for a first incoming XML instance;
computer usable program code for generating a comparison agent, the comparison agent including:
the application-specific parser for the first incoming XML instance, the application-specific parser including XML path language (XPATH) and a comparison code action pair; and
an element value of the first incoming XML instance; and
computer usable program code for evaluating a second incoming XML instance with the comparison agent at runtime.

9. The computer program product as claimed in claim 8, wherein the computer usable program code for creating the application-specific parser is performed by a compiler.

10. The computer program product as claimed in claim 8, wherein the second incoming XML instance includes an element value.

11. The computer program product as claimed in claim 10, wherein the computer usable code for evaluating the second incoming XML instance with the comparison agent includes comparing the element value of the first incoming XML instance with the element value of the second incoming XML instance.

12. The computer program product as claimed in claim 8, wherein the computer useable code for generating a comparison agent is performed by a compiler.

13. The computer program product as claimed in claim 8, wherein the element value of the first incoming XML instance is retrieved by XPATH.

14. The computer program product as claimed in claim 8, wherein the computer usable code for evaluating the second incoming XML instance with the comparison agent includes the comparison agent parsing the second XML instance.

15. A method of comparing Extensible Markup Language (XML) instances, comprising the steps of:
creating a comparison agent, the comparison agent including:
an application-specific parser for a first incoming XML instance, the application-specific parser including a semantic action definition for asserting an element value of the first incoming XML instance; and
evaluating a second incoming XML instance with the comparison agent at runtime, the second incoming XML instance being parsed by the application-specific parser.

16. The method as claimed in claim 15, wherein the second incoming XML instance includes an element value.

17. The method as claimed in claim 16, wherein the step of evaluating the second incoming XML instance with the comparison agent includes comparing the element value of the first incoming XML instance with the element value of the second incoming XML instance.

18. The method as claimed in claim 15, wherein the step of generating a comparison agent is performed by a compiler.

19. The method as claimed in claim 15, wherein the element value of the first incoming XML instance is retrieved by XML path language (XPATH).

20. The method as claimed in claim 15, wherein the application-specific parser is generated by an XML specification including an XML schema and semantic actions.
